(19) United States
(12) Patent Application Publication
(10) Pub. No.: US 2012/0187668 A1
(43) Pub. Date: Jul. 26, 2012

(54) INFLATORS AND METHODS OF MAKING INFLATORS FOR SAFE TRANSPORT AND USE WITH INFLATABLE AIRBAG CUSHIONS

(76) Inventors: Robert E. Lewis, West Haven, UT (US); Larry D. Rose, South Weber, UT (US); Matthew A. Cox, Centerville, UT (US); Kirk Rasmussen, West Point, UT (US)

(21) Appl. No.: 13/014,008

(22) Filed: Jan. 26, 2011

(51) Int. Cl. B60R 21/26; B23P 11/00

(52) U.S. Cl. 280/740; 280/741; 29/428

(57) ABSTRACT

Inflators for safe transport and use with an inflatable airbag cushion and airbag systems include a diffuser comprising a first aperture and at least one vent aperture each disposed in a lateral sidewall of the diffuser. The first aperture and the at least one vent aperture are positioned to face in at least substantially opposite directions in the diffuser. A filter is positioned within the diffuser and includes an outer surface having a lateral extent less than a lateral extent of an inner surface of the lateral sidewall of the diffuser, resulting in a gap between the outer surface of the filter and the inner surface of the lateral sidewall of the diffuser. At least one reaction device is coupled to a longitudinal end of the diffuser. Methods of making such inflators are also included.

### TECHNICAL FIELD

The present disclosure relates generally to inflatable airbag cushions for motor vehicles. More specifically, various embodiments of the present disclosure relate to inflators and methods of making and transporting inflators used in inflatable airbag systems for motor vehicles.

### BACKGROUND

Modern motor vehicles typically employ various occupant protection systems that self-actuate from an undeployed to a deployed state without the need for intervention by the occupant. Such systems often include an inflatable occupant protection system in the form of a cushion or bag, commonly referred to as an “airbag cushion,” which is now a legal requirement for many new vehicles. Such airbag cushions are typically installed in various locations in a vehicle and may deploy into one or more locations within the vehicle between the occupant and certain parts of the vehicle interior, such as the doors, steering wheel, instrument panel, dashboard or the like, to prevent or cushion the occupant from forcibly striking such parts of the vehicle interior.

Various types or forms of occupant protection systems have been developed or tailored to provide desired vehicle occupant protection based on either or both the position or placement of the occupant within the vehicle and the direction or nature of the vehicle collision. For example, driver and passenger inflatable cushion installations have found wide usage for providing protection to drivers and front seat passengers, respectively, in the event of a head-on type of collision. Other installations have found wide usage for providing protection to vehicle occupants in the event of a side impact (e.g., side collision, roll-over).

The airbag cushion is conventionally housed in an uninflated and folded condition to minimize space requirements. In the event of an accident, an accelerometer within the vehicle measures the abnormal deceleration and triggers the expulsion of rapidly expanding gases supplied or produced by a device commonly referred to as an “inflator.” The expanding gases fill the airbags, which immediately inflate in front of the driver and/or passenger to provide protection from impact against a windshield, dashboard, or other surfaces of the vehicle interior.

### BRIEF SUMMARY

Various embodiments of the present disclosure comprise inflators for use with an airbag cushion, yet are thrust neutral for shipping. In one or more embodiments, an inflator may include a hollow body defining a diffusion chamber. The hollow body may include a first longitudinal end and an opposing second longitudinal end. A first aperture may be disposed in a lateral sidewall of the hollow body. At least one vent aperture may also be disposed in the lateral sidewall of the hollow body and may be positioned at least substantially opposite from the first aperture. A filter can be positioned at least substantially within the diffusion chamber and may form a channel between an inner surface of the hollow body and an outer surface of the filter. A first reaction device can be coupled to one of the first longitudinal end or the second longitudinal end of the hollow body.

Additional embodiments of airbag cushion inflators adapted for use with an inflatable airbag system include a diffuser comprising a first aperture and at least one vent aperture each disposed in a lateral sidewall of the diffuser. The first aperture and the at least one vent aperture are generally positioned to face in at least substantially opposite directions. A filter can be positioned at least partially within the diffuser. The filter may comprise an outer surface having a lateral extent less than a lateral extent of an inner surface of the lateral sidewall of the diffuser to form a gap between the outer surface of the filter and the inner surface of the lateral sidewall of the diffuser. A first reaction device can be coupled to a longitudinal end of the diffuser.

Other embodiments of the present disclosure comprise methods of forming an inflator adapted for use with an inflatable airbag cushion system. One or more embodiments of such methods may include forming a first aperture and at least one vent aperture in a lateral sidewall of a diffuser. The first aperture and the at least one vent aperture are positioned in the lateral sidewall facing in opposite directions from each other. A filter can be disposed at least partially within the diffuser to form a channel between an outer surface of the filter and an inner surface of the lateral sidewall of the diffuser. A first reaction chamber can be coupled to a longitudinal end of the diffuser.

### BRIEF DESCRIPTION OF THE SEVERAL VIEWS OF THE DRAWINGS

Exemplary embodiments of the disclosure will become more fully apparent from the following description and appended claims, taken in conjunction with the accompanying drawings. Understanding that these drawings depict only exemplary embodiments and are, therefore, not to be considered limiting of the disclosure's scope, the exemplary embodiments of the disclosure will be described with additional specificity and detail through use of the accompanying drawings in which:

FIG. 1 is a cross-sectioned view illustrating an example of an airbag inflator adapted for dual-stage deployment according to at least one embodiment of the present disclosure;

FIG. 2 is a cross-sectioned view illustrating an example of an airbag inflator adapted for single-stage deployment according to at least one embodiment of the present disclosure;

FIG. 3 is a cross-sectioned view illustrating a portion of an example of a diffuser with mounting studs positioned therein according to at least one embodiment of the present disclosure;

FIG. 4 is a cross-sectioned view illustrating positioning of a plug in an aperture of either one of the airbag inflators shown in FIG. 1 or FIG. 2; and

FIG. 5 is a flow diagram illustrating at least one embodiment of a method for forming an inflator.

### DETAILED DESCRIPTION

The illustrations presented herein are, in some instances, not actual views of any particular inflator or inflatable airbag system, but are merely idealized representations which are employed to describe the present disclosure. Additionally, elements common between figures may retain the same numerical reference designation.

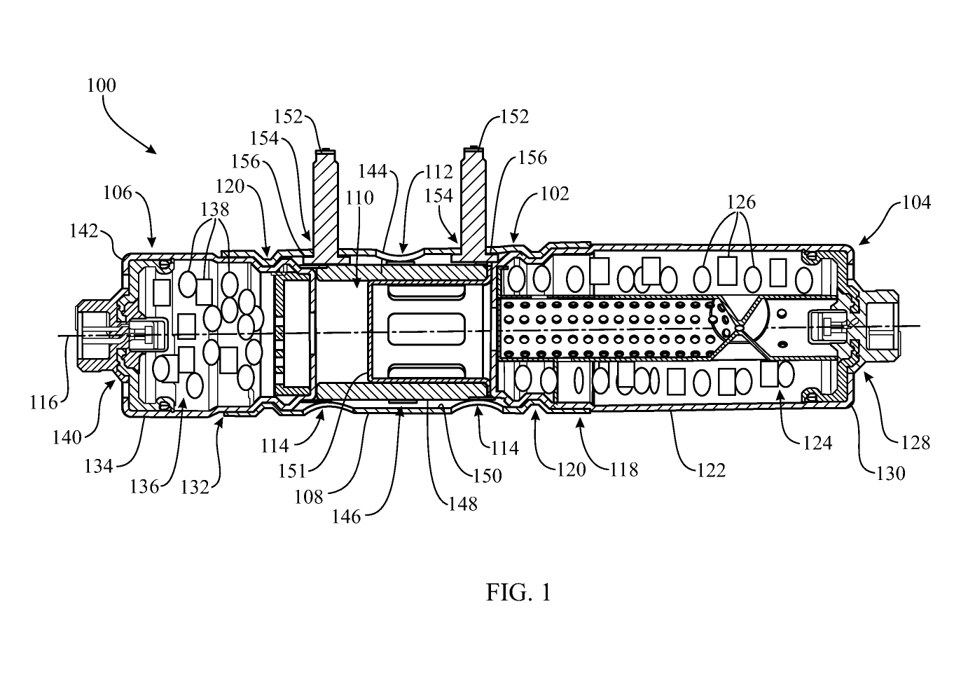

Various embodiments of the present disclosure include airbag cushion inflators for use in inflatable airbag systems for motor vehicles. FIG. 1 is a cross-sectioned view illustrating an airbag inflator 100 according to at least one embodiment of the present disclosure. The inflator 100 includes a diffuser 102 and at least one reaction device coupled to the diffuser 102. In the embodiment shown in FIG. 1, the inflator 100 is adapted for dual-stage deployment and includes both a first reaction device 104 and a second reaction device 106 coupled to the diffuser 102.

The diffuser 102 is formed of a hollow body 108 that defines a diffusion chamber 110. A first aperture 112 and one or more vent apertures 114 are disposed in a lateral sidewall of the hollow body 108. The first aperture 112 is positioned at least substantially opposite from the one or more vent apertures 114. That is, the first aperture 112 and the one or more vent apertures 114 can face away from each other in at least substantially opposite directions. For example, the first aperture 112 may be located about 180° about a central longitudinal axis 116 away from the one or more vent apertures 114. The first aperture 112 can have a flow area that is similar to a flow area of the one or more vent apertures 114. It is noted that although only one first aperture 112 is illustrated, the hollow body 108 may comprise a plurality of first apertures 112.

With the first aperture 112 and the one or more vent apertures 114 being positioned in opposite directions and having similar flow areas, the diffuser 102 is effectively configured to be thrust neutral. That is, the net force of any fluid flowing outward from the diffuser 102 is at least substantially zero. For instance, the force resulting from a fluid flowing outward from the diffusion chamber 110 through the first aperture 112 will be at least substantially cancelled by a similar, yet opposing force resulting from the fluid also flowing through the one or more vent apertures 114 located in the opposite direction. As a result, if the inflator 100 were to accidentally deploy, for example during shipping, the inflator 100 is unlikely to become a projectile that could potentially cause substantial damage and/or injury.

The first reaction device 104 is adapted to generate a supply of inflation fluid during deployment of the inflator 100. The first reaction device 104 can be coupled to a first longitudinal end 118 of the hollow body 108 of the diffuser 102. As illustrated in FIG. 1, the first reaction device 104 may be coupled to the first longitudinal end 118 of the diffuser 102 using only crimped attachment means 120. In this manner, the inflator 100 may be assembled without the need for welding or other forms of coupling with elevated heat that can weaken the material comprising the diffuser 102 and/or the first reaction device 104.

The first reaction device 104 includes a first reaction housing 122 that defines a first reaction chamber 124. The first reaction chamber 124 is adapted to contain a quantity of gas generant 126 used to generate (e.g., converted into) the supply of inflation fluid during deployment of the inflator 100. The quantity of gas generant 126 may comprise at least one of a quantity of gas generant material (as illustrated), a quantity of stored gas (not shown), or a combination of gas generate material and stored gas (e.g., a hybrid inflator).

The first reaction device 104 further includes an initiator device 128 coupled to the first reaction housing 122. The initiator device 128 is positioned so that it is in sufficient communication with the gas generant 126 to initiate a reaction of the gas generant 126 for producing the supply of inflation gas during deployment. In the embodiment shown, the initiator device 128 is coupled to the first reaction housing 122 using an orbital crimp 130 in the first reaction housing 122.

The inflator 100 further includes a second reaction device 106 coupled to a second longitudinal end 132 of the hollow body 108 of the diffuser 102, opposite from the first longitudinal end 118. Similar to the first reaction device 104, the second reaction device 106 may be coupled to the second longitudinal end 132 of the diffuser 102 using only crimped attachment means 120.

Like the first reaction device 104, the second reaction device 106 includes a second reaction housing 134 defining a second reaction chamber 136. The second reaction chamber 136 can contain a second quantity of gas generant 138 used to generate additional supply of inflation fluid during deployment. The quantity of gas generant 138 may comprise a quantity of gas generant material (as shown), a quantity of stored gas (not shown), or a combination of gas generate material and stored gas (e.g., a hybrid inflator). The second reaction device 106 also includes an initiator device 140 coupled to the second reaction housing 134 and positioned in sufficient communication with the gas generant 138 to be capable of initiating a reaction thereof. The initiator device 140 may also be coupled to the second reaction housing 134 with an orbital crimp 142 in the second reaction housing 134.

A filter 144 is positioned inside the diffusion chamber 110 of the diffuser 102. The filter 144 has a substantially hollow shape and is positioned in the diffusion chamber 110 with the hollow interior portion located in fluid-flow communication with the first reaction device 104 and the second reaction device 106. The filter 144 is shaped and positioned in the diffusion chamber 110 to form a gap (or channel) 146 between an outer surface 148 of the filter 144 and an inner surface 150 of the hollow body 108 of the diffuser 102. That is, the filter 144 comprises the outer surface 148 having a lateral extent that is less than a lateral extent of the inner surface 150 of the diffuser's 102 hollow body 108, resulting in the gap 146 between the two surfaces. By way of example and not limitation, the gap (or channel) 146 between the outer surface 148 of the filter 144 and the inner surface 150 of the hollow body 108 within the diffusion chamber 110 may be about 1.5 mm, or any other suitable gap size.

During deployment, a signal is received by at least one of the initiator devices 128 and/or 140 causing the particular initiator device to ignite/combust the gas generant 126 and/or 138. The quantities of gas generant 126 and 138 of the first reaction device 104 and second reaction device 106, respectively, may be ignited simultaneously or at different times, according to various implementations. Upon ignition/combustion of the gas generant 126, 140, the inflation gas is generated and flows (as shown by the arrows in FIG. 1) from the respective reaction chamber (124, 136) into the hollow interior portion of the filter 144 located within the diffusion chamber 110 of the diffuser 102. In implementations in which the first reaction device 104 deploys before the second reaction device 106 (i.e., a dual stage ignition), a baffle 151 may be positioned in the diffusion chamber 110. The baffle 151 is adapted to cool the hot inflation gas entering the diffusion chamber 110, so as to prevent the hot inflation gas from the first reaction device 104 from igniting the gas generant 138 of the second reaction device 106.

The inflation gas in the hollow portion of the filter 144 can flow through the filter 144 and into the gap (or channel) 146 between the filter 144 and the diffuser 102. Upon occurrence of an unintentional deployment, such as during shipping, the inflation gas within the gap 146 may exit from the diffuser 102 through one of the first aperture 112 or the vent aperture 114. After the inflator 100 is installed for use and the first aperture 112 is occluded, as described below, the inflation gas within the gap 146 can exit from the diffuser 102 through one of the vent apertures 114.

The gap 146 is adapted to enable inflation gases to flow around the inner surface 150 of the hollow body 108. As the inflation gases flow through the gap 146, any particulate in the inflation gases may collect on the inner surface 150 of the hollow body 108. Furthermore, because the gap 146 is located around the entire filter 144, the gap 146 facilitates increased usage of the filter 144. That is, in conventional devices, inflation gases typically only flow through those portions of the filter which are located at or near an aperture through which the inflation gas exits. In the present inflator 100, the gap 146 can allow inflation gas to flow through substantially all portions of the filter 144 into the area of the gap (or channel) 146. The inflation gas can then flow from the area of the gap 146 to the first aperture 112 or the vent aperture 114. This may also increase cooling of conventionally hot inflation gases before the inflation gases exit the diffusion chamber 110.

The inflator 100 may further include a plurality of mounting studs 152 for use in securing the inflator 100 to some portion of an inflatable airbag system or motor vehicle in which the inflator 100, together with an airbag cushion, can be disposed. The mounting studs 152 are positioned to extend through respective stud apertures 154 in the hollow body 108 of the diffuser 102. Each mounting stud 152 includes a stud head 156 that is disposed in the gap 146 between the outer surface 148 of the filter 144 and the inner surface 150 of the hollow body 108. In at least some embodiments, the stud apertures 154 are aligned with the vent apertures 114 to enable the mounting studs 152 to be inserted through the vent apertures 114 as they are inserted into the stud apertures 154 with the stud heads 156 located in the gap 146. That is, the vent apertures 114 may be located and sized so that a mounting stud 152 (including the stud head 156) can be put through the respective vent aperture 114 and into the respective stud aperture 154 until the stud head 156 is located in the gap 146. Such configuration can facilitate the insertion of mounting studs 152 that are substantially longer than the diffusion chamber 110 and would not be able to fit sufficiently within the diffusion chamber 110 to be disposed in a stud aperture 154.

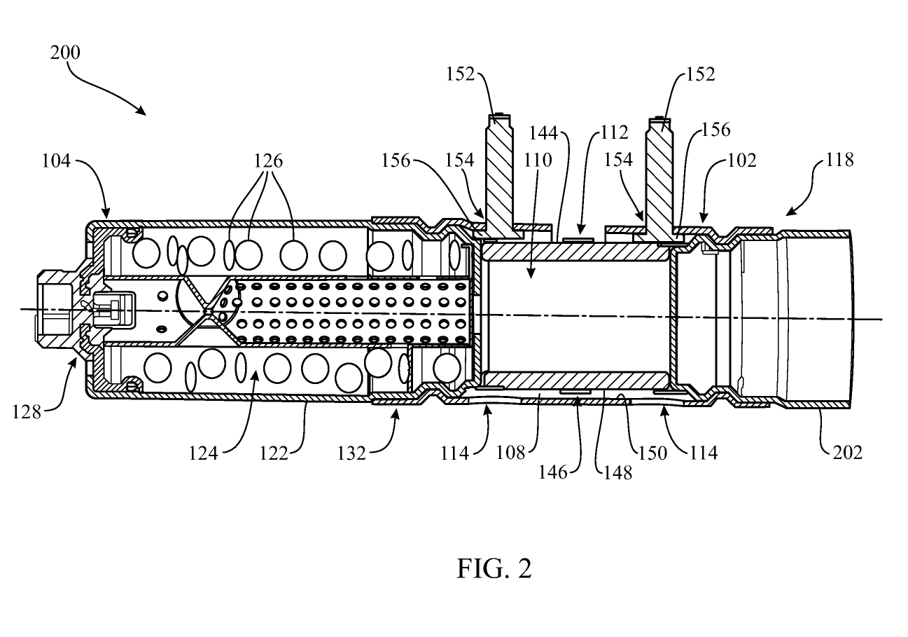

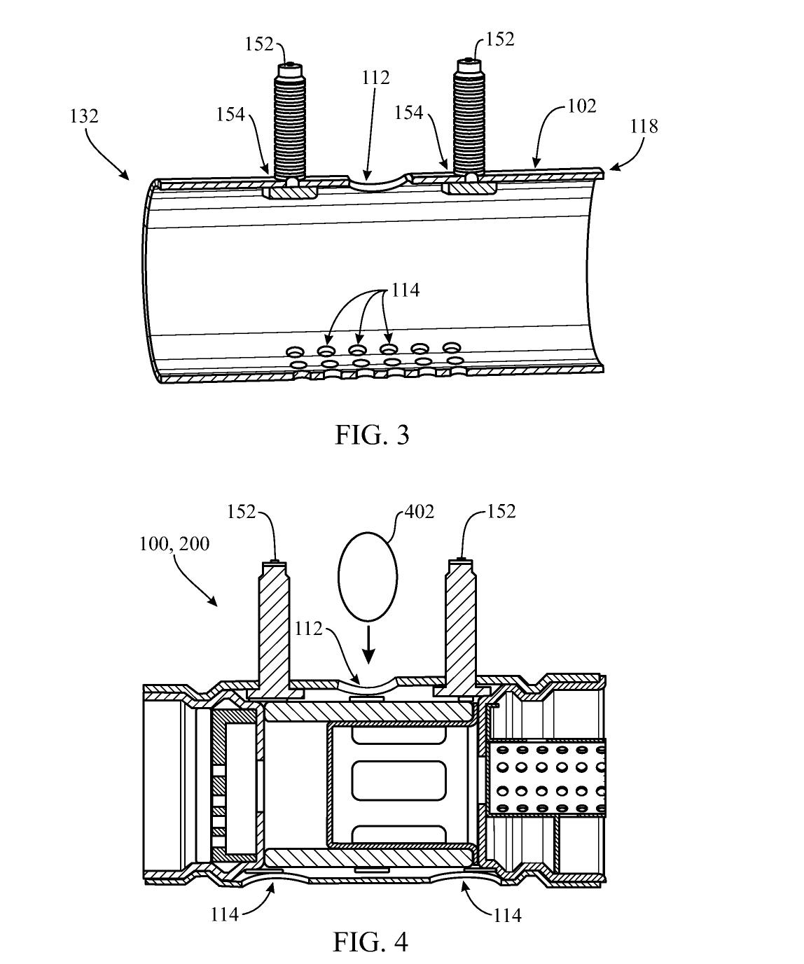

In at least some embodiments, the mounting studs 152 may be inserted into the stud apertures 154 from inside the diffuser 102. For example, as shown in FIG. 3, some embodiments of the diffuser 102 may comprise one or more vent apertures 114 that are too small for the mounting studs 152 to pass through, that are not aligned with the stud apertures 154, or both. In such embodiments, as well as in those embodiments with vent apertures 114 as described previously and as illustrated in FIGS. 1 and 2, the mounting studs 152 can be positioned within the diffuser 102 from, for example, the first longitudinal end 118 or the second longitudinal end 132 and then inserted into the stud apertures 154 from inside the diffuser 102.

Turning to FIG. 2, a cross-sectioned view illustrating an example of an airbag inflator 200 is shown according to at least one other embodiment. The inflator 200 is similar in many respects to the inflator 100 in FIG. 1, and the various numbered components are similar to those described above. In general, the inflator 200 includes a diffuser 102 comprising a hollow body 108 that defines a diffusion chamber 110. A first aperture 112 and one or more vent apertures 114 are disposed in a lateral sidewall of the hollow body 108, and positioned at least substantially opposite from each other, as described above with reference to FIG. 1. As noted above, the diffuser 102 is effectively configured to be thrust neutral with the first aperture 112 and the one or more vent apertures 114 being positioned in opposite directions and having similar flow areas. Being thrust neutral facilitates safe shipping of the inflator 100 prior to installation in a vehicle.

A filter 144 is positioned inside the diffusion chamber 110 to form a gap (or channel) 146 between an outer surface 148 of the filter 144 and an inner surface 150 of the hollow body 108 of the diffuser 102. A plurality of mounting studs 152 are positioned to extend through respective stud apertures 154 in the hollow body 108 of the diffuser 102, with a stud head 156 that is disposed in the gap 146 between the outer surface 148 of the filter 144 and the inner surface 150 of the hollow body 108.

One difference between the inflator 200 and the inflator 100 of FIG. 1 involves the number of reaction devices coupled to the diffuser 102. In the embodiment shown in FIG. 2, the inflator 200 includes only a single reaction device, shown as the first reaction device 104 coupled to the second longitudinal end 132 of the hollow body 108. At the first longitudinal end 118, a blank 202 is coupled to the hollow body 108 to enclose the first longitudinal end 118 of the hollow body 108.

The first reaction device 104 generally includes a first reaction housing 122 that defines a first reaction chamber 124 adapted to contain a quantity of gas generant 126 used to generate (e.g., converted into) the supply of inflation fluid during deployment of the inflator 200. The first reaction device 104 also includes an initiator device 128 coupled to the first reaction housing 122 and positioned to be in sufficient communication with the gas generant 126 to initiate a reaction of the gas generant 126 for producing the supply of inflation gas during deployment.

As noted above, the inflators 100, 200 of FIGS. 1 and 2, respectively, include both a first aperture 112 and one or more vent apertures 114, which result in the inflators 100, 200 being at least substantially thrust neutral. As a result, if the inflator 100, 200 were to accidentally deploy, for example during shipping, the inflator 100, 200 is unlikely to become a projectile. However, in some instances, such as after the inflator 100, 200 is installed into a motor vehicle, it may be desired to direct the inflation gas during deployment in a single general direction, making the inflator 100, 200 thrust positive. For example, it may be desired to adapt the inflator 100, 200 to direct the inflation gas through only the one or more vent apertures 114, to direct the inflation gas into an airbag cushion. Therefore, according to various embodiments of the inflators described herein, and as illustrated in FIG. 4, a plug 402 may be positioned within the first aperture 112. The partial view of the cross-sectioned inflator shown in FIG. 4 may be either of the inflator 100 of FIG. 1 or the inflator 200 of FIG. 2, and such a plug 402 may also be employed in embodiments such as that illustrated in FIG. 3. In any case, a plug 402 can be disposed in the first aperture 112 to effectively prevent gas from passing through the first aperture 112. If a plurality of first apertures 112 are employed, a plug 402 can be positioned in each of the first apertures 112.

The plug 402 may comprise any suitable material and may be suitably shaped and sized to occlude the first aperture 112. According to some embodiments, the plug 402 comprises a rubber material. In some embodiments, the plug 402 may be installed at the same time the inflator 100, 200 is coupled to some portion of an inflatable airbag system for a motor vehicle. The plug 402 may be retained in position when the mounting studs 152 are coupled to some portion of the inflatable airbag system or vehicle by trapping the plug 402 between the inflator 100, 200 and the portion of the inflatable airbag system or vehicle to which the mounting studs 152 are coupled. For example, when the mounting studs 152 of the inflator 100, 200 are coupled to the inflatable airbag system or vehicle, some portion of the inflatable airbag system or vehicle may come into contact with the plug 402 to hold the plug 402 in place.

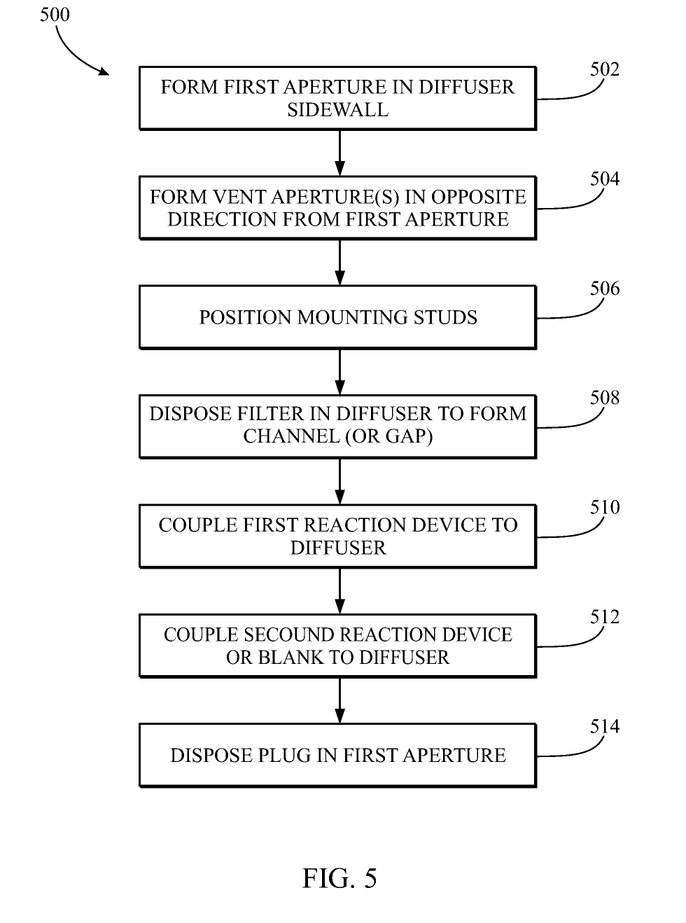

Additional embodiments of the present disclosure relate to methods of forming inflators for use in inflatable airbag systems. FIG. 5 is a flow diagram illustrating at least one embodiment of a method for forming an inflator, such as one of the inflators illustrated in FIGS. 1-4. With reference to FIG. 5, as well as to the elements of FIG. 1, the method 500 includes formation of a first aperture 112 in a sidewall of a diffuser 102 at step 502. One or more vent apertures 114 can also be formed in the sidewall of the diffuser 102, at step 504. The one or more vent apertures 114 are positioned in the sidewall of the diffuser 102 to face in an opposite direction from the first aperture 112. For example, the one or more vent apertures 114 can be positioned about 180° away from the first aperture 112.

A plurality of mounting studs 152 may be positioned to extend through the lateral sidewall of the diffuser at step 506. In some embodiments, a respective stud aperture 154 may be formed at least substantially aligned with a vent aperture 114. In such embodiments, the mounting studs 152 may be positioned to extend through the respective stud aperture 154 by inserting the mounting stud 152, including the stud head 156, through the vent aperture 114, into the diffusion chamber 110, and through the stud aperture 154. In some embodiments, the mounting studs 152 may be positioned within the diffusion chamber 110 from, for example, the first longitudinal end 118 or the second longitudinal end 132 and then inserted into the stud apertures 154 from inside the diffusion chamber 110. In such embodiments, a bar or other apparatus may be positioned within the diffusion chamber 110 for applying a force on the mounting studs 152 for disposing the mounting studs 152 into the stud apertures 154. As noted above, the stud head 156 of each mounting stud 152 is positioned on the interior side of the diffuser 102.

At step 508, the filter 144 is disposed at least partially within the diffuser 102 to form the gap (or channel) 146 between the outer surface 148 of the filter 144 and the inner surface 150 of the lateral sidewall of the diffuser 102. The gap 146 can enable the stud heads 156 to be positioned as noted above, without interfering with the filter 144. The gap 146 can also enable inflation gases to flow through the gap 146 before exiting the diffuser 102 during deployment.

At step 510 a first reaction device 104 can be coupled to one of the first or second longitudinal ends 118, 132 of the diffuser 102. In addition, either a second reaction device 106 or a blank 202 (see FIG. 2) can be coupled to the other longitudinal end of the diffuser 102 at step 512.

At this stage, the inflator is thrust neutral and may be safely shipped prior to installation into a motor vehicle. During installation of the inflator into a motor vehicle, and so the inflator will be capable of deployment, a plug 402 (see FIG. 4) is disposed within the first aperture 112 to at least substantially occlude the first aperture 112 at step 514.

As noted above, the plug 402 may be disposed in the first aperture 112 at the time or prior to when the mounting studs 152 are coupled to some module of an inflatable airbag system. The plug 402 can be retained in position in the first aperture 112 by trapping the plug 402 between the inflator 100, 200 and the portion of the inflatable airbag system to which the mounting studs 152 are coupled.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

1. An inflator for use with an inflatable airbag cushion system, comprising:
a hollow body defining a diffusion chamber, the hollow body including:
a first longitudinal end and an opposing second longitudinal end;
a first aperture disposed in a lateral sidewall of the hollow body; and
at least one vent aperture disposed in the lateral sidewall of the hollow body and positioned at least substantially opposite from the first aperture;
a filter positioned at least substantially within the diffusion chamber and forming a channel between an inner surface of the hollow body and an outer surface of the filter; and
a first reaction device coupled to one of the first longitudinal end or the second longitudinal end of the hollow body.

2. The inflator of claim 1, wherein the first reaction device comprises:
a first reaction housing defining a reaction chamber containing a quantity of gas generant; and
an initiator device coupled to the first reaction housing and in sufficient communication with the gas generant to initiate a reaction for producing a supply of inflation gas during deployment.

3. The inflator of claim 1, further comprising a second reaction device coupled to the other of the first longitudinal end or the second longitudinal end of the hollow body, opposite from the first reaction device.

4. The inflator of claim 1, further comprising a blank coupled to the other of the first longitudinal end or the second longitudinal end of the hollow body, opposite from the first reaction device, wherein the blank encloses the longitudinal end to which it is coupled.

5. The inflator of claim 1, further comprising a plug disposed to at least substantially occlude the first aperture within the lateral sidewall of the hollow body, causing the previously thrust neutral inflator to become thrust positive.

6. The inflator of claim 1, further comprising a plurality of mounting studs extending through respective stud apertures in the hollow body, each mounting stud including a stud head disposed in the channel between the inner surface of the hollow body and the outer surface of the filter.

7. The inflator of claim 6, wherein each stud aperture is axially aligned with a respective vent aperture so that a mounting stud may be inserted through the respective stud aperture by means of the respective vent aperture.

8. A thrust-neutral inflator adapted for use with an inflatable airbag system, comprising:
a diffuser comprising a first aperture and at least one vent aperture each disposed in a lateral sidewall of the diffuser, wherein the first aperture and the at least one vent aperture are positioned to face in at least substantially opposite directions;
a filter positioned at least partially within the diffuser, the filter comprising an outer surface having a lateral extent less than a lateral extent of an inner surface of the lateral sidewall of the diffuser to form a gap between the outer surface of the filter and the inner surface of the lateral sidewall of the diffuser; and
a first reaction device coupled to a longitudinal end of the diffuser.

9. The thrust-neutral inflator of claim 8, wherein the first aperture and the at least one vent aperture are positioned about 180° apart around a central longitudinal axis of the diffuser.

10. The thrust-neutral inflator of claim 8, wherein the first reaction device comprises:
a first reaction housing defining a reaction chamber that contains a quantity of gas generant; and
an initiator device coupled to the first reaction housing and positioned in sufficient communication with the gas generant to initiate a reaction for producing a supply of inflation gas during deployment.

11. The thrust-neutral inflator of claim 8, further comprising a second reaction device coupled to another longitudinal end of the diffuser, opposite from the first reaction device.

12. The thrust-neutral inflator of claim 8, further comprising a blank coupled to another longitudinal end of the diffuser, opposite from the first reaction device, wherein the blank at least substantially encloses the other longitudinal end to which it is coupled.

13. The thrust-neutral inflator of claim 8, further comprising a plug disposed to enclose the first aperture within the lateral sidewall of the diffuser, causing the previously thrust neutral airbag cushion inflator to become thrust positive.

14. The thrust-neutral inflator of claim 8, further comprising a plurality of mounting studs extending through respective stud apertures in the lateral sidewall of the diffuser, each mounting stud including a stud head disposed in the gap between the outer surface of the filter and the inner surface of the lateral sidewall of the diffuser.

15. The thrust-neutral inflator of claim 14, wherein each stud aperture is axially aligned with a respective vent aperture so that a mounting stud may be inserted through the respective stud aperture by means of the respective vent aperture.

16. A method of forming a thrust-neutral inflator adapted for use with an inflatable airbag cushion system, the method comprising:
forming a first aperture in a lateral sidewall of a diffuser;
forming at least one vent aperture in the lateral sidewall of the diffuser, the at least one vent aperture being positioned to face in an opposite direction from the first aperture;
disposing a filter at least partially within the diffuser to form a channel between an outer surface of the filter and an inner surface of the lateral sidewall of the diffuser; and
coupling a first reaction device to a longitudinal end of the diffuser.

17. The method of claim 16, wherein forming the at least one vent aperture in the lateral sidewall of the diffuser positioned to face in an opposite direction from the first aperture comprises forming the at least one vent aperture in the lateral sidewall of the diffuser about 180° apart from the first aperture.

18. The method of claim 16, further comprising:
coupling a second reaction device to another longitudinal end of the diffuser, opposite from the first reaction device.

19. The method of claim 16, further comprising:
disposing a plug within the first aperture to occlude the first aperture formed in the lateral sidewall of the diffuser.

20. The method of claim 16, further comprising:
positioning a plurality of mounting studs to extend through the lateral sidewall of the diffuser, wherein a stud head of each mounting stud is disposed in the channel between the outer surface of the filter and the inner surface of the lateral sidewall of the diffuser.

21. The method of claim 20, wherein the at least one vent aperture is formed at least substantially axially aligned with at least one stud aperture formed in the lateral sidewall of the diffuser, and wherein positioning the plurality of mounting studs to extend through the lateral sidewall of the diffuser comprises:
inserting each mounting stud into the diffuser through the at least one vent aperture; and
disposing each mounting stud through a respective stud aperture.

22. The method of claim 20, wherein positioning the plurality of mounting studs to extend through the lateral sidewall of the diffuser comprises:
inserting each mounting stud into the diffuser through a longitudinal end; and
disposing each mounting stud through a respective stud aperture formed in the lateral sidewall of the diffuser.
